(19) United States
(12) Patent Application Publication
(10) Pub. No.: US 2025/0391352 A1
(43) Pub. Date: Dec. 25, 2025

(54) DISPLAY DEVICE, METHOD OF DRIVING THE SAME AND ELECTRONIC DEVICE INCLUDING THE DISPLAY DEVICE

(71) Applicant: Samsung Display Co., Ltd., Yongin-si (KR)

(72) Inventors: Sang Hun KIM, Yongin-si (KR); Seung Jun SHIN, Yongin-si (KR); Nack Hyeon KEUM, Yongin-si (KR); Jae Joong MIN, Yongin-si (KR)

(21) Appl. No.: 19/225,932

(22) Filed: Jun. 2, 2025

(30) Foreign Application Priority Data
Jun. 19, 2024 (KR) 10-2024-0079869
Aug. 7, 2024 (KR) 10-2024-0105690

(51) Int. Cl. G09G 3/3225

(52) U.S. Cl. CPC G09G 3/3225; G09G 2310/027; G09G 2310/08; G09G 2320/0252; G09G 2330/028

(57) ABSTRACT

A display device includes: a display panel including a pixel configured to emit light in response to an emission signal; and a display panel driver configured to drive the display panel, wherein the display panel driver is configured to generate the emission signal of a first frequency in a first period in which input image data is received from a processor, and to generate the emission signal of a frequency different from the first frequency in a second period different from the first period.

### CROSS-REFERENCE TO RELATED APPLICATION

The present application claims priority to and the benefit of Korean Patent Application No. 10-2024-0079869, filed on Jun. 19, 2024, in the Korean Intellectual Property, and Korean Patent Application No. 10-2024-0105690, filed on Aug. 7, 2024, in the Korean Intellectual Property Office, the entire disclosures of each of which are incorporated herein by reference.

### BACKGROUND

### (a) Field

Aspects of some embodiments of the present disclosure relate to a display device, a method of driving the same and electronic device including the display device.

### (b) Description of the Related Art

As information technology has developed, importance of a display device, which is a connection medium between a user and information, has been highlighted. Accordingly, the use of display devices such as liquid crystal display devices, organic light emitting display devices, and inorganic light emitting display devices is increasing.

A processor (for example, a graphic processing unit (GPU)) provides input image data to a display device. When rendering by the processor is delayed, a lagging period may occur between periods in which input image data is provided. In this case, a delay time until a display panel displays a new image may be longer depending on a frequency of an emission signal.

The above information disclosed in this Background section is only for enhancement of understanding of the background and therefore the information discussed in this Background section does not necessarily constitute prior art.

### SUMMARY

Aspects of some embodiments of the present disclosure include a display device that may relatively reduce a delay time.

Aspects of some embodiments of the present disclosure include a method of driving a display device that drives the display device.

According to some embodiments of the present disclosure, a display device includes: a display panel including a pixel that emit light in response to an emission signal; and a display panel driver that drives the display panel, wherein the display panel driver generates the emission signal of a first frequency in a first period in which input image data is received from a processor, and generates the emission signal of a frequency different from the first frequency in a second period different from the first period.

According to some embodiments, the display panel driver may predict an input of next input image data based on a first synchronization signal corresponding to an input of the input image data to generate a second synchronization signal, and may determine a frequency of the emission signal based on the second synchronization signal.

According to some embodiments, when the first synchronization signal is not enabled while the second synchronization signal is enabled, the display panel driver may generate the emission signal of the frequency different from the first frequency.

According to some embodiments, the display panel driver may generate the emission signal of the first frequency when the first synchronization signal and the second synchronization signal are simultaneously enabled.

According to some embodiments, a frequency of the emission signal in the second period may gradually increase.

According to some embodiments, a frequency of the emission signal in the first period following the second period may gradually decrease to the first frequency.

According to some embodiments, the display panel driver may compensate for a gamma voltage in the second period.

According to some embodiments, the display panel driver may compensate for the gamma voltage in a direction of increasing luminance in the second period.

According to some embodiments, the display panel driver may predict an input of next input image data based on a first synchronization signal corresponding to an input of the input image data to generate a second synchronization signal, may determine a frequency of the emission signal based on the second synchronization signal, and may compensate for the gamma voltage when the first synchronization signal is not enabled while the second synchronization signal is enabled.

According to some embodiments, the display panel driver may increase a bias voltage that refreshes a source electrode of a driving transistor of the pixel in the second period.

According to some embodiments of the present disclosure, a method of driving a display device includes: generating an emission signal of a first frequency in a first period in which input image data is received from a processor; generating the emission signal of a frequency different from the first frequency in a second period different from the first period; and providing the emission signal to a pixel.

According to some embodiments, the method of driving the display device may further include predicting an input of next input image data based on a first synchronization signal corresponding to an input of the input image data to generate a second synchronization signal, wherein a frequency of the emission signal may be determined based on the second synchronization signal.

According to some embodiments, the generating of the emission signal of the frequency different from the first frequency may include generating the emission signal of the frequency different from the first frequency when the first synchronization signal is not enabled while the second synchronization signal is enabled.

According to some embodiments, the generating of the emission signal of the first frequency may include generating the emission signal of the first frequency when the first synchronization signal and the second synchronization signal are simultaneously enabled.

According to some embodiments, a frequency of the emission signal in the second period may gradually increase.

According to some embodiments, a frequency of the emission signal in the first period following the second period may gradually decrease to the first frequency.

According to some embodiments, the method of driving the display device may further include compensating for a gamma voltage in the second period.

According to some embodiments, the gamma voltage may be compensated in a direction of increasing luminance in the second period.

According to some embodiments, the method of driving the display device may further include predicting an input of next input image data based on a first synchronization signal corresponding to an input of the input image data to generate a second synchronization signal, wherein a frequency of the emission signal may be determined based on the second synchronization signal, and the compensating of the gamma voltage may include compensating for the gamma voltage when the first synchronization signal is not enabled while the second synchronization signal is enabled.

According to some embodiments, the method of driving the display device may further include increasing a bias voltage that refreshes a source electrode of a driving transistor of the pixel in the second period.

According to some embodiments, a display device may relatively reduce a delay time until displaying a new image by generating a high frequency emission signal in a second period.

However, the characteristics of embodiments according to the present disclosure are not limited to the above-described characteristics, and may be variously extended without departing from the spirit and scope of embodiments according to the present disclosure.

### BRIEF DESCRIPTION OF THE DRAWINGS

FIG. 1 illustrates a block diagram of a display device according to some embodiments of the present disclosure.

FIG. 2 illustrates a block diagram of an example of a driving controller of FIG. 1.

FIG. 3 illustrates a timing diagram of an example in which the driving controller of FIG. 2 controls a display panel.

FIG. 4 illustrates a timing diagram of an example in which a driving controller of a display device according to some embodiments of the present disclosure controls a display panel.

FIG. 5 illustrates a timing diagram of an example in which a driving controller of a display device according to some embodiments of the present disclosure controls a display panel.

FIG. 6 is a flowchart illustrating aspects of a method of driving a display device according to some embodiments of the present disclosure.

FIG. 7 illustrates a block diagram of an electronic device according to some embodiments of the present invention.

### DETAILED DESCRIPTION

Hereinafter, aspects of some embodiments of the present disclosure will be described in more detail with reference to the accompanying drawings. The following description is intended to provide only a sufficient disclosure to enable the understanding of the operation of the invention, and any other disclosure may be omitted to avoid obscuring the scope of the invention. In addition, the inventive concept may be embodied in different forms and is not limited to the embodiments set forth herein. The embodiments described herein are provided for the purpose of describing the technical concept of the invention in sufficient detail for those skilled in the art to easily practice it.

Throughout the specification, when it is described that an element is “connected” to another element, this includes not only being “directly connected”, but also being “indirectly connected” with another device in between. The terms used herein are for the purpose of describing specific embodiments and are not intended to limit the scope of the invention. Throughout the specification, unless explicitly described to the contrary, the word “comprise” and variations such as “comprises” or “comprising” will be understood to imply the inclusion of stated elements but not the exclusion of any other elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms first, second, etc. may be used herein to describe various constituent elements, these constituent elements should not be limited by these terms. These terms are used to distinguish one constituent element from another. Thus, a first constituent element discussed below could be termed a second constituent element without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (for example, rotated 90 degrees or at other orientations), and, as such, the spatially relative descriptors used herein interpreted accordingly.

Various embodiments are described herein with reference to sectional illustrations that are schematic illustrations of idealized embodiments. As such, variations from the shapes of the illustrations as a result, for example, of manufacturing techniques and/or tolerances, are to be expected. Thus, the embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

Hereinafter, aspects of some embodiments of the present disclosure will be described in more detail with reference to the accompanying drawings.

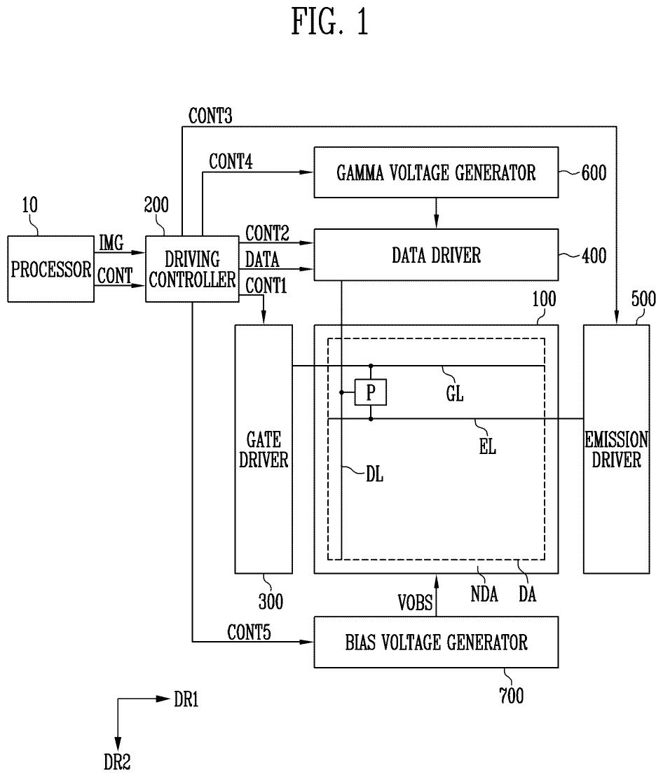

FIG. 1 illustrates a block diagram of a display device according to some embodiments of the present disclosure.

Referring to FIG. 1, the display device may include a display panel 100 and a display panel driver. The display panel driver may include a driving controller 200, a gate driver 300, a data driver 400, an emission driver 500, a gamma voltage generator 600, and a bias voltage generator 700. According to some embodiments, at least two components from among the driving controller 200, the data driver 400, the gamma voltage generator 600, and the bias voltage generator 700 may be integrated into a single chip.

The display panel 100 may include a display area DA displaying images and a non-display area NDA located adjacent to (e.g., in a periphery or outside a footprint of) the display area DA. According to some embodiments, the gate driver 300 and the emission driver 500 may be mounted in the non-display area NDA.

The display panel 100 may include a plurality of pixels P electrically connected to a plurality of gate lines GL, a plurality of data lines DL, and a plurality of emission lines EL. The gate lines GL and the emission lines EL may extend in a first direction DR1, and the data lines DL may extend in a second direction DR2 intersecting the first direction DR1.

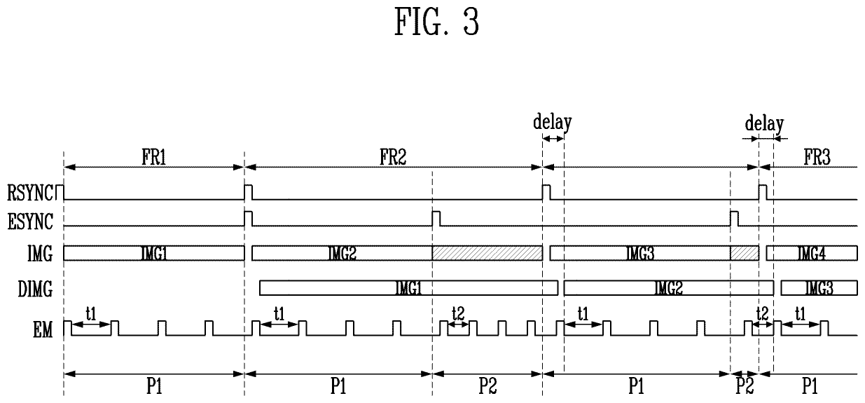

The driving controller 200 may receive input image data IMG and an input control signal CONT from a processor 10 (for example, a graphic processing unit (GPU) and the like). For example, the input image data IMG may include red image data, green image data, and blue image data. According to some embodiments, the input image data IMG may further include white image data. For another example, the input image data IMG may include magenta image data, yellow image data, and cyan image data. The input control signal CONT may include a master clock signal and data enable signal. The input control signal CONT may further include a vertical synchronization signal and a horizontal synchronization signal. The input control signal CONT may include a rendering synchronization signal RSYNC (see FIG. 3).

The driving controller 200 may generate a first control signal CONT1, a second control signal CONT2, a third control signal CONT3, a fourth control signal CONT4, a fifth control signal CONT5, and a data signal DATA based on the input image data IMG and the input control signal CONT.

The driving controller 200 may generate the first control signal CONT1 for controlling the operation of the gate driver 300 based on the input control signal CONT to output it to the gate driver 300. The first control signal CONT1 may include a vertical start signal and gate clock signal.

The driving controller 200 may generate the second control signal CONT2 for controlling the operation of the data driver 400 based on the input control signal CONT to output it to the data driver 400. The second control signal CONT2 may include a horizontal start signal and a load signal.

The driving controller 200 may receive the input image data IMG and the input control signal CONT to generate the data signal DATA. The driving controller 200 may output the data signal DATA to the data driver 400.

The driving controller 200 may generate the third control signal CONT3 for controlling the operation of the emission driver 500 based on the input control signal CONT to output it to the emission driver 500. The third control signal CONT3 may include a vertical start signal and an emission clock signal.

The driving controller 200 may generate the fourth control signal CONT4 for controlling the operation of the gamma voltage generator 600 based on the input control signal CONT to output it to the gamma voltage generator 600.

The driving controller 200 may generate the fifth control signal CONT5 for controlling the operation of the bias voltage generator 700 based on the input control signal CONT to output it to the bias voltage generator 700.

The gate driver 300 may generate gate signals for driving the gate lines GL in response to the first control signal CONT1 received from the driving controller 200. The gate driver 300 may output the gate signals to the gate lines GL. For example, the gate driver 300 may sequentially output the gate signals to the gate lines GL.

The data driver 400 may receive the second control signal CONT2 and the data signal DATA from the driving controller 200. The data driver 400 may receive a gamma voltage VGAMMA from the gamma voltage generator 600. The data driver 400 may generate data voltages obtained by converting the data signal DATA into an analog voltage based on the gamma voltage VGAMMA. For example, the data driver 400 may output a voltage corresponding to the grayscale of the data signal DATA among the gamma voltages VGAMMA as a data voltage. The data driver 400 may output the data voltages to the data line DL.

The emission driver 500 may generate emission signals for driving the emission lines EL in response to the third control signal CONT3 received from the driving controller 200. The emission driver 500 may output the emission signals to the emission lines EL. For example, the emission driver 500 may sequentially output the emission signals to the emission lines EL.

The gamma voltage generator 600 may generate the gamma voltage VGAMMA in response to the fourth control signal CONT4 input from the driving controller 200. For example, the gamma voltage generator 600 may generate gamma voltages VGAMMA corresponding to grayscales.

The bias voltage generator 700 may generate a bias voltage VOBS in response to the fifth control signal CONT5 input from the driving controller 200. The bias voltage VOBS may refresh a source electrode of a driving transistor of the pixel P. For example, the bias voltage VOBS may be provided to the pixel P in a period in which an emission signal EM (see FIG. 3) has an inactive level.

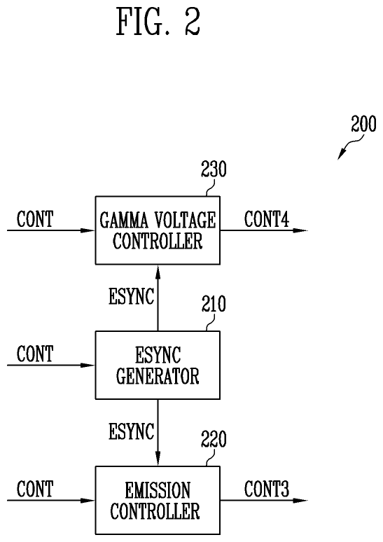

FIG. 2 is a block diagram of an example of a driving controller of FIG. 1, and FIG. 3 illustrates a timing diagram of an example in which the driving controller of FIG. 2 controls a display panel.

For ease of description, in FIG. 2, components except for a prediction synchronization signal generator 210, an emission controller 220, and a gamma voltage controller 230 are omitted.

Referring to FIG. 1 to FIG. 3, the display panel 100 can display input image data IMG of the previous frame. For example, when the processor 10 provides first input image data IMG1 to the driving controller 200 in a first frame FR1, an image DIMG displayed on the display panel 100 in a second frame FR2 may be an image corresponding to the first input image data IMG1. This is applied to the second to fourth input image data IMG2 to IMG4.

When the rendering by the processor 10 is delayed, a lagging period (hereinafter referred to as a second period P2) may occur between a period in which the input image data IMG is provided (hereinafter referred to as a first period P1). In this case, a delay time until the display panel 100 displays a new image may be longer depending on the frequency of the emission signal EM. However, the display panel driver may relatively reduce the delay time by providing the emission signal EM of a higher frequency in the second period P2 than in the first period P1 to the display panel 100. Hereinafter, it will be described in detail.

The driving controller 200 may include a prediction synchronization signal generator 210, an emission controller 220, and a gamma voltage controller 230.

The prediction synchronization signal generator 210 may generate a prediction synchronization signal ESYNC based on the input control signal CONT. For example, the prediction synchronization signal generator 210 may generate a prediction synchronization signal ESYNC based on a rendering synchronization signal RSYNC.

The rendering synchronization signal RSYNC may be a signal corresponding to an input of the input image data IMG. For example, when the processor 10 provides the input image data IMG to the driving controller 200, the processor 10 may provide an enabled rendering synchronization signal RSYNC to the driving controller 200.

The prediction synchronization signal generator 210 may generate a prediction synchronization signal ESYNC by predicting an input of the next input image data based on the rendering synchronization signal RSYNC. For example, the prediction synchronization signal ESYNC may be enabled some time after the rendering synchronization signal RSYNC is enabled. For example, when there is no second period P2, the prediction synchronization signal ESYNC and the rendering synchronization signal RSYNC may be simultaneously (or concurrently) enabled. For example, when there is the second period P2, the rendering synchronization signal RSYNC may not be enabled when the prediction synchronization signal ESYNC is enabled. That is, the display panel driver may distinguish between the first period P1 and the second period P2 in which the input image data IMG is input based on whether the prediction synchronization signal ESYNC and the rendering synchronization signal RSYNC are simultaneously (or concurrently) enabled.

The emission controller 220 may generate the third control signal CONT3 based on the input control signal CONT and the prediction synchronization signal ESYNC. The third control signal CONT3 may include information on the frequency of the emission signal EM.

The emission controller 220 may determine the frequency of the emission signal EM as a first frequency in the first period P1, and determine the frequency of the emission signal EM as a frequency different from the first frequency in the second period P2. In addition, the emission driver 500 may receive the third control signal CONT3 from the emission controller 220 and generate the emission signal EM at the frequency determined by the emission controller 220. For example, the emission controller 220 may determine a frequency of the emission signal EM based on the prediction synchronization signal ESYNC. For example, in the first period P1, the length of the period in which the emission signal EM has an activation level (that is, a low voltage level) may be a first length t1, and in the second period P2, the length of the period in which the emission signal EM has an activation level may be a second length t2 shorter than the first length t1.

For example, when the prediction synchronization signal ESYNC and the rendering synchronization signal RSYNC are simultaneously (or concurrently) enabled, the emission controller 220 may determine the frequency of the emission signal EM as the first frequency. For example, when the rendering synchronization signal RSYNC is not enabled while the prediction synchronization signal ESYNC is enabled, the emission controller 220 may determine the frequency of the emission signal EM to be a frequency different from the first frequency.

The pixel P may emit light in response to the emission signal EM. For example, when the emission signal EM has an activation level, the pixel P may emit light. For example, when the emission signal EM has an inactive level (for example, a high voltage level), a data voltage may be written to the pixel P.

The higher the frequency of the emission signal EM, the closer the distance between periods having an inactive level of the emission signal EM. The display panel 100 may display a new image by writing a data voltage in a period in which the emission signal EM has an inactive level. In addition, because the emission controller 220 determines the frequency of the emission signal EM to be high in the second period P2, the maximum length of the delay time may be relatively reduced.

The gamma voltage controller 230 may generate the fourth control signal CONT4 based on the prediction synchronization signal ESYNC. The fourth control signal CONT4 may include information on the compensation value of the gamma voltage VGAMMA.

The gamma voltage controller 230 may compensate for the gamma voltage in the second period P2. The gamma voltage controller 230 may compensate for the gamma voltage VGAMMA in the direction of increasing luminance in the second period P2. For example, when the luminance increases as the data voltage written to the pixel P increases, the gamma voltage controller 230 may increase the gamma voltage VGAMMA in the second period P2.

For example, the gamma voltage controller 230 may not compensate for the gamma voltage VGAMMA when the prediction synchronization signal ESYNC and the rendering synchronization signal RSYNC are simultaneously (or concurrently) enabled. For example, when the rendering synchronization signal RSYNC is not enabled while the prediction synchronization signal ESYNC is enabled, the gamma voltage controller 230 may compensate for the gamma voltage VGAMMA.

As the frequency of the emission signal EM increases, the length of the period in which the emission signal EM has an activation level becomes shorter, and accordingly, the luminance may decrease. Accordingly, the gamma voltage controller 230 may compensate for the gamma voltage VGAMMA in the second period P2 to compensate for the luminance decrease.

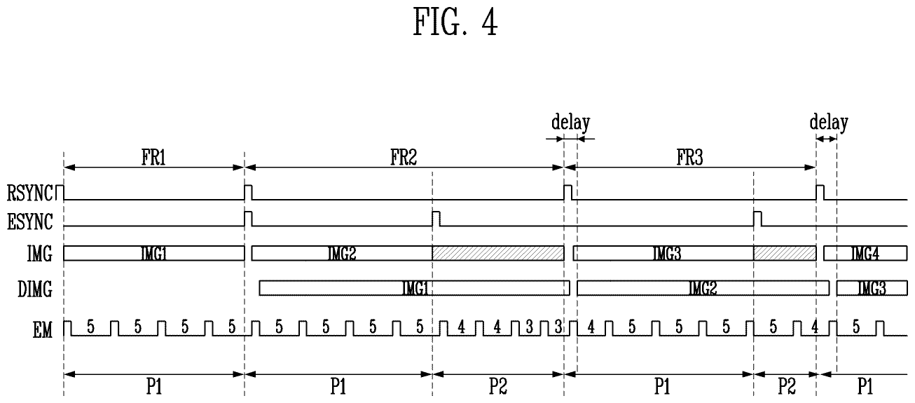

FIG. 4 illustrates a timing diagram of an example in which a driving controller of a display device according to some embodiments of the present disclosure controls a display panel.

FIG. 4 illustrates a length of a period in which the emission signal has an activation level as a relative number.

The display device according to the present embodiments is substantially the same as the configuration of the display device described with reference to FIG. 1 to FIG. 3, except that the frequency of the emission signal EM is gradually controlled, so the same reference numerals and reference symbols are used for the same or similar components, and some redundant descriptions may be omitted.

Referring to FIG. 4, the frequency of the emission signal EM in the second period P2 may gradually increase. As the length of the second period P2 increases, the maximum length of the delay time may be further relatively reduced by increasing the frequency of the emission signal EM. For example, as shown in FIG. 4, the length of the period in which the emission signal EM has an activation level in the second period P2 may gradually decrease from 4.

The frequency of the emission signal EM in the first period P1 following the second period P2 may gradually decrease to the first frequency. For example, the length of the period in which the emission signal EM has an activation level at the first frequency is 5, and the length of the period in which the emission signal EM has an activation level in the first period P1 following the second period P2 may increase from 4 to 5.

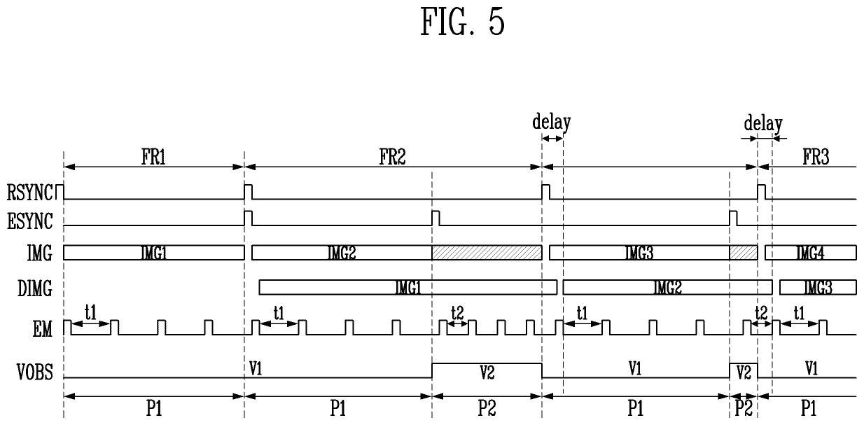

FIG. 5 illustrates a timing diagram of an example in which a driving controller of a display device according to some embodiments of the present disclosure controls a display panel.

The display device according to the present embodiments is substantially the same as the configuration of the display device described with reference to FIG. 1 to FIG. 3, except for controlling the bias voltage VOBS, so the same reference numerals and reference symbols are used for the same or similar components, and some redundant descriptions may be omitted.

Referring to FIG. 5, the driving controller 200 may increase the bias voltage VOBS in the second period P2. For example, the bias voltage VOBS in the first period P1 may be a first voltage V1, and the bias voltage VOBS in the second period P2 may be a second voltage V2 greater than the first voltage V1.

For example, the driving controller 200 may not increase the bias voltage VOBS when the prediction synchronization signal ESYNC and the rendering synchronization signal RSYNC are simultaneously (or concurrently) enabled. For example, the driving controller 200 may increase the bias voltage VOBS when the rendering synchronization signal RSYNC is not enabled while the prediction synchronization signal ESYNC is enabled.

As the frequency of the emission signal EM increases, the length of the period in which the emission signal EM has an activation level becomes shorter, and accordingly, the luminance may decrease. Accordingly, the driving controller 200 may increase the bias voltage VOBS in the second period P2 to compensate for the luminance decrease.

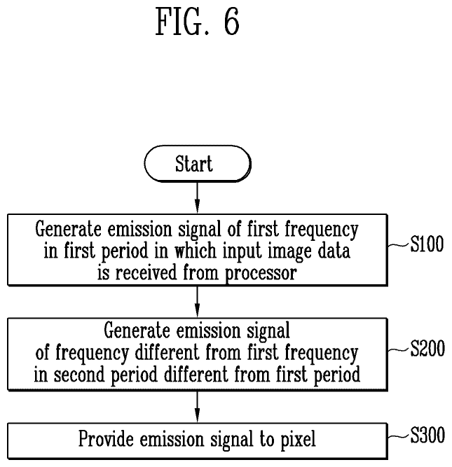

FIG. 6 illustrates a flowchart illustrating aspects a method of driving a display device according to some embodiments of the present disclosure. Although FIG. 6 illustrates various operations in a method of driving a display device according to some embodiments, embodiments according to the present disclosure are not limited thereto, and according to various embodiments, the method may include additional operations or fewer operations, or the order of operations may vary unless otherwise stated or implied, without departing from the spirit and scope of embodiments according to the present disclosure.

Referring to FIG. 6, the method of driving the display device may include generating an emission signal of a first frequency in a first period in which input image data is received from a processor (S100), generating an emission signal of a frequency different from the first frequency in a second period different from the first period (S200), and providing an emission signal to a pixel (S300). A detailed description thereof has been described with reference to FIG. 1 to FIG. 5, so some redundant description thereof may be omitted.

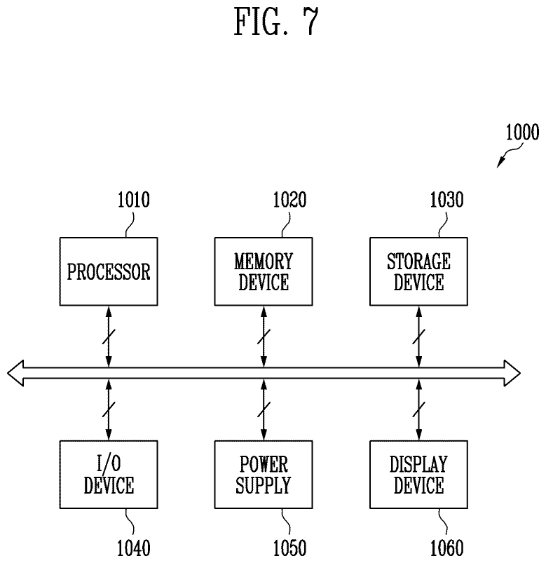

FIG. 7 illustrates a block diagram of an electronic device according to some embodiments of the present invention.

Referring to FIG. 7, an electronic device 1000 may include a processor 1010, a memory device 1020, a storage device 1030, an input/output device 1040, a power supply 1050, and a display device 1060. In this case, the display device 1060 may be the display device of FIG. 1. In addition, the electronic device 1000 may further include several ports capable of communicating with a video card, a sound card, a memory card, a USB device, and the like, or communicating with other systems. According to some embodiments, the electronic device 1000 may be implemented as a smart phone. However, this is an example, and the electronic device 1000 is not limited thereto. For example, the electronic device 1000 may be implemented as a mobile phone, a television, a video phone, a smart pad, a smart watch, a tablet PC, a vehicle navigation, a computer monitor, a laptop, a head mounted display device, or the like.

The processor 1010 may perform specific calculations or tasks. In some embodiments, the processor 1010 may be a micro-processor, a central processing unit, an application processor, or the like. The processor 1010 may be connected to other constituent elements through an address bus, a control bus, and a data bus. In some embodiments, the processor 1010 may also be connected to an extension bus such as a peripheral component interconnect (PCI) bus. The processor 1010 which is illustrated in FIG. 7, may include aspects of and be described identically to the processor 10 which is illustrated in FIG. 1. Hereinafter, overlapping descriptions will be omitted.

The memory device 1020 may store data necessary for operations of the electronic device 1000. For example, the memory device 1020 may include non-volatile memory devices such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, and a ferroelectric random access memory (FRAM) device, and/or volatile memory devices such as a dynamic random access memory (DRAM) device, a static random access memory (SRAM) device, and a mobile DRAM device.

The storage device 1030 may include a solid state drive (SSD), a hard disk drive (HDD), a CD-ROM, and the like.

The input/output device 1040 may include input devices such as a keyboard, a keypad, a touch pad, a touchscreen, mouse, and the like, and output devices such as a speaker, a printer, and the like. In some embodiments, the display device 1060 may be included in the input/output device 1040.

The power supply 1050 may supply power necessary for the operation of the electronic device 1000. For example, the power supply 1050 may be a power management integrated circuit (PMIC).

The display device 1060 may display an image corresponding to visual information of the electronic device 1000. In this case, the display device 1060 may be an organic light emitting display device or a quantum dot light emitting display device, but is not limited thereto. The display device 1060 may be connected to other constituent elements through the buses or other communication links.

Although certain embodiments and implementations have been described herein, other embodiments and modifications will be apparent from this description.

Accordingly, embodiments according to the present disclosure are not limited to the specifically described embodiments, but rather to the broader scope of the appended claims and various modifications and equivalent arrangements as would be apparent to a person of ordinary skill in the art.

Aspects of some embodiments of the present disclosure may be applied to a display device and an electronic device including the same. For example, the present disclosure may be applied to a digital TV, a 3D TV, a mobile phone, a smart phone, a tablet computer, a VR device, a PC, a home electronic device, a laptop computer, a PDA, a PMP, a digital camera, a music player, a portable game console, a navigation, and the like.

While this disclosure has been described in connection with what is presently considered to be practical embodiments, it is to be understood that the invention is not limited to the disclosed embodiments, but, on the contrary, is intended to cover various modifications and equivalent arrangements included within the spirit and scope of the appended claims, and their equivalents.

What is claimed is:

1. A display device comprising:
a display panel including a pixel configured to emit light in response to an emission signal; and
a display panel driver configured to drive the display panel,
wherein the display panel driver is configured to generate the emission signal of a first frequency in a first period in which input image data is received from a processor, and to generate the emission signal of a frequency different from the first frequency in a second period different from the first period.

2. The display device of claim 1, wherein the display panel driver is configured to:
predict an input of next input image data based on a first synchronization signal corresponding to an input of the input image data to generate a second synchronization signal; and
determines a frequency of the emission signal based on the second synchronization signal.

3. The display device of claim 2, wherein based on the first synchronization signal not being enabled while the second synchronization signal is enabled, the display panel driver is configured to generate the emission signal of the frequency different from the first frequency.

4. The display device of claim 2, wherein
the display panel driver is configured to generate the emission signal of the first frequency based on the first synchronization signal and the second synchronization signal being simultaneously enabled.

5. The display device of claim 1, wherein a frequency of the emission signal in the second period gradually increases.

6. The display device of claim 1, wherein a frequency of the emission signal in the first period following the second period gradually decreases to the first frequency.

7. The display device of claim 1, wherein the display panel driver is configured to compensate for a gamma voltage in the second period.

8. The display device of claim 7, wherein the display panel driver is configured to compensate for the gamma voltage in a direction of increasing luminance in the second period.

9. The display device of claim 7, wherein the display panel driver is configured to:
predict an input of next input image data based on a first synchronization signal corresponding to an input of the input image data to generate a second synchronization signal;
determine a frequency of the emission signal based on the second synchronization signal; and
compensate for the gamma voltage when the first synchronization signal is not enabled while the second synchronization signal is enabled.

10. The display device of claim 1, wherein the display panel driver is configured to increase a bias voltage that refreshes a source electrode of a driving transistor of the pixel in the second period.

11. A method of driving a display device, comprising:
generating an emission signal of a first frequency in a first period in which input image data is received from a processor;
generating the emission signal of a frequency different from the first frequency in a second period different from the first period; and
providing the emission signal to a pixel.

12. The method of driving the display device of claim 11, further comprising
predicting an input of next input image data based on a first synchronization signal corresponding to an input of the input image data to generate a second synchronization signal,
wherein a frequency of the emission signal is determined based on the second synchronization signal.

13. The method of driving the display device of claim 12, wherein
generating the emission signal of the frequency different from the first frequency includes generating the emission signal of the frequency different from the first frequency based on the first synchronization signal not being enabled while the second synchronization signal is enabled.

14. The method of driving the display device of claim 12, wherein
generating the emission signal of the first frequency includes generating the emission signal of the first frequency based on the first synchronization signal and the second synchronization signal being simultaneously enabled.

15. The method of driving the display device of claim 11, wherein a frequency of the emission signal in the second period gradually increases.

16. The method of driving the display device of claim 11, wherein a frequency of the emission signal in the first period following the second period gradually decreases to the first frequency.

17. The method of driving the display device of claim 11, further comprising compensating for a gamma voltage in the second period,
wherein the gamma voltage is compensated in a direction of increasing luminance in the second period.

18. The method of driving the display device of claim 17, further comprising:
predicting an input of next input image data based on a first synchronization signal corresponding to an input of the input image data to generate a second synchronization signal,
wherein a frequency of the emission signal is determined based on the second synchronization signal, and
the compensating of the gamma voltage includes compensating for the gamma voltage when the first synchronization signal is not enabled while the second synchronization signal is enabled.

19. The method of driving the display device of claim 11, further comprising increasing a bias voltage that refreshes a source electrode of a driving transistor of the pixel in the second period.

20. An electronic device, comprising:
a processor to provide input image data; and
a display device including a display panel configured to display an image based on the input image data,
wherein the display device comprising a display panel driver configured to drive the display panel,
wherein the display panel driver is configured to generate an emission signal of a first frequency in a first period in which the input image data is received from the processor, and to generate the emission signal of a frequency different from the first frequency in a second period different from the first period.
